(19) United States
(12) Patent Application Publication
(10) Pub. No.: US 2008/0245207 A1
(43) Pub. Date: Oct. 9, 2008

(54) Laser Marking Electric Cutting Tool

(76) Inventor: Shuming Wu, Jiangsu Province (CN)

Correspondence Address: DORITY & MANNING, P.A., POST OFFICE BOX 1449, GREENVILLE, SC, 29602-1449, US

(21) Appl. No.: 12/066,970

(22) PCT Filed: Oct. 25, 2006
(86) PCT No.: PCT/CN06/02846

§ 371 Date: Mar. 14, 2008

(30) Foreign Application Priority Data
Oct. 27, 2005 (CN) 200520076782.3

(51) Int. Cl. B26D 5/00

(52) U.S. Cl. 83/821

(57) ABSTRACT

A laser guided cutting tool of the present invention comprises a base for supporting a workpiece to be cut, a bracket fixed on the base, a cutting assembly pivotally mounted on the bracket, and a laser generator. The laser generator is disposed within a pivot shaft which is mounted on the bracket, and the pivot shaft has an aperture permitting a laser beam projected from the laser generator to pass through and project onto the workpiece directly under the cutting assembly. Because the laser generator is disposed inside of the pivot shaft, the cutting tool is compact in size. Furthermore, the laser generator is rarely defiled or damaged as it is held and covered by the sidewall of the pivot shaft.

### CROSS-REFERENCE TO RELATED APPLICATIONS

This application claims priority to Chinese Application No. CN2005/20076782.3 filed Oct. 27, 2005, and International Application Serial No. PCT/CN2006/002846 filed Oct. 25, 2006.

### FIELD OF THE INVENTION

The present invention relates to an electric cutting tool, especially to a cutting tool with laser alignment means for guiding cutting.

### BACKGROUND OF THE INVENTION

Cutting tools are widely used in many fields, e.g. carpentry, construction industry, upholstery and etc. A miter saw, one kind of the cutting tools for example, generally comprises a base for supporting a workpiece to be cut, a bracket fixed on the base, and a cutting assembly pivotally mounted on the bracket and movable from an upper limited position to a lower limited position thereby to cut the workpiece.

Cutting tools are typically equipped with a laser generator which is capable of emitting a laser beam onto the surface of the workpiece so that the workpiece may be more accurately positioned before cutting.

It is proved through practice that different positions of the laser generator on a power cutting tool lead to different cutting quality and operating convenience. In order to avoid vibration caused due to the laser generator being disposed above the cutting assembly (U.S. Pat. No. 5,375,495), and to solve the problem that the laser beam cannot reach the area directly under the blade as the laser generator is disposed on a side of the cutting assembly (DE Pat. No. 3,406,904), U.S. Patent Application 2001/0049988A1 discloses a cutting tool whereby the laser generator is disposed on either bracket or cutting assembly so that the laser beam may reach the area directly beneath the blade. Thus, the interference of blade thickness and laser beam width to cutting orientation may be eliminated and cutting precision may be ensured.

However, the above disclosed tool has following shortages. In one aspect, since the laser generator is exposed in the way that the cut chip flows, it is apt to be defiled or damaged during operation. In another aspect, the adjusting mechanism of the laser generator is complex and incompact.

### OBJECT AND SUMMARY OF THE INVENTION

The object of the present invention is to provide an improved power cutting tool which has laser alignment device that is compact and rarely defiled or damaged.

To achieve above object, the cutting tool of the present invention comprises a base for supporting a workpiece to be cut, a bracket fixed on the base, a cutting assembly, a pivot shaft connected between the bracket and the cutting assembly such that the cutting assembly is pivotally movable from an upper limit position to a lower limit position to cut the workpiece, and a laser alignment device mounted in the pivot shaft, as well as, said pivot shaft has an aperture permitting the laser beam to pass through and project onto the workpiece directly under said cutting assembly.

Obviously, because the laser generator is disposed inside of the pivot shaft, the cutting tool is compact in size. Furthermore, the laser generator is rarely defiled or damaged as it is held and covered by the sidewall of the pivot shaft.

### BRIEF DESCRIPTION OF THE DRAWINGS

The present invention will become more fully understood by reference to the following detailed description thereof when read in conjunction with the attached drawings, wherein:

FIG. 1 is a side view of an embodiment of the present invention.

FIG. 2 is a sectional view of the pivot shaft and the laser generator disposed therein.

### DETAILED DESCRIPTION OF THE PREFERRED EMBODIMENTS

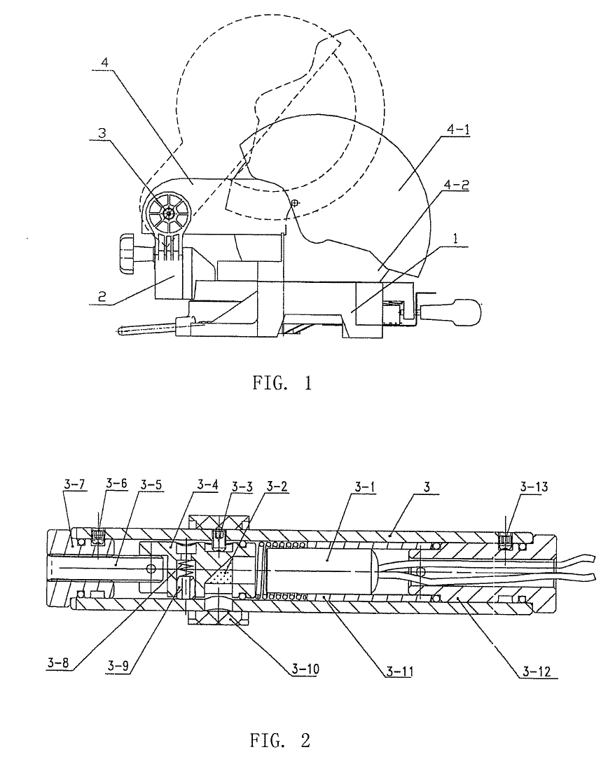

As shown in FIG. 1, the cutting tool of the present invention is embodied as a miter saw which mainly comprises a base 1 for supporting a workpiece to be cut, a bracket 2 fixed on the base, and a cutting assembly 4 pivotally mounted on the bracket 2 through a pivot shaft 3. During cutting operation, a blade 4-2 is driven to rotate by a motor. When the operator presses down the handle which is fixed on a blade guard 4-1, the cutting assembly 4 pivots about the pivot shaft 3 from an upper limit position (shown with dashed line portion) to a lower limit position (shown with solid line portion) such that the workpiece on the base 1 is cut apart.

Detailed configuration of a laser alignment device according to the embodiment of the present invention is shown in FIG. 2. The pivot shaft 3 which is mounted in the bracket 2 is tube shaped such as to permit a laser generator 3-1, which is secured in a bushing 3-11, being received in one end thereof. The bushing 3-11 is fixed to one end of an adjusting knob 3-12 through a pin. The adjusting knob 3-12 has an annular groove defined round its periphery at the one end and an adjusting cap at the other end. Via turning the adjusting knob 3-12, the laser generator 3-1 may be circumferentially orientated. After the laser generator being 3-1 orientated as required, a tightening screw 3-13 can be pressed onto the annular groove of adjusting knob 3-12 to fix the laser generator 3-1 on the position. Power cords of the laser generator 3-1 pass through a center hole of the adjusting knob 3-12.

A prism holder 3-4 is received in another end of the pivot shaft 3. The holder holds a prism 3-2 which has a reflecting surface inclined on a position at where a center axis of the laser generator 3-1 intersects a center axis of an aperture on the pivot shaft 3. With such a configuration, the laser beam generated from the laser generator 3-1 will be reflected by the prism and runs through the aperture to project onto the surface of the workpiece which is directly under the blade.

In order that the laser beam can exactly project on the position where a cutting mark is required, the prism holder 3-4, which is radially biased by a pin 3-9 through a spring 3-8 at the middle portion thereof, is pivotally connected to one end of an adjusting screw 3-5, while another end of the adjusting screw 3-5 is threaded on an adjusting knob 3-7, so that the prism holder 3-4, as well as the prism 3-2 held therein, may be axially moved by rotating the adjusting knob 3-7. After the adjustment, the adjusting knob 3-7 may be fixed by another tightening screw 3-6. Moreover, the prism holder 3-4, as well as the prism 3-2 held therein, may be pivotally moved by a screw 3-3 which is mounted on the pivot shaft 3 and at the direction biased by the pin 3-9. As a result, the laser beam may be aligned with the left or right side of the blade, or may project on the position directly under the blade, so that various operating requirements may be achieved.

As shown in FIG. 2, a transparent cover 3-10 is mounted on the pivot shaft 3 and covers the aperture to keep the prism from being defiled.

With the laser alignment device described hereinabove, cutting precision is ensured, and which facilities operation. And also, the whole device is compact, well covered from being defiled and easy to be adjusted.

According to mechanical design principles, the pivot shaft 3 shown in FIG. 1 may be mounted in two manners, which are, to be fixed relative to the bracket 2 or to be fixed relative to the cutting assembly 4. Thereby, if the pivot shaft 3 is fixed relative to the bracket 2, the laser beam generated from the laser generator is immovable relative to the base during cutting; if the pivot shaft 3 is fixed relative to the cutting assembly 4, the laser beam is movable along with the cutting assembly 4.

In summary, compare with the prior art, the present invention has remarkable advantages. The above described embodiment is not intended to limit the scope of the present invention. Other embodiments in variations to the preferred embodiment will be apparent to those skilled in the art and may be made without departing from the spirit and scope of the invention as defined in the appended claims.

1. A laser guided cutting tool, comprising:
a base for supporting a workpiece to be cut,
a bracket fixed on the base,
a cutting assembly pivotally mounted on the bracket, and
a laser generator;
wherein the laser generator is disposed within a pivot shaft which is mounted on the bracket, and the pivot shaft has an aperture permitting a laser beam projected from the laser generator to pass through and project onto the workpiece directly under the cutting assembly.

2. A cutting tool of claim 1, wherein the pivot shaft is tube shaped, and has a first end containing the laser generator and a second end containing a prism holder which holds a prism, wherein the prism has a reflecting surface inclined on a position where a center axis of the laser generator intersects a center axis of the aperture on the pivot shaft.

3. A cutting tool of claim 2, wherein the laser generator is secured in a bushing which is fixed relative to one end of a first adjusting knob, the other end of the first adjusting knob is defined with a cap.

4. A cutting tool of claim 2, wherein the prism holder is radially biased by a pin through a spring at the middle portion thereof, and is pivotally connected to one end of an adjusting screw, while another end of the adjusting screw is threaded on a second adjusting knob, and wherein a screw is mounted on the pivot shaft and at the direction biased by the pin.

5. A cutting tool of claim 4, wherein the pivot shaft is fixed relative to the bracket.

6. A cutting tool of claim 4, wherein the pivot shaft is fixed relative to the cutting assembly.

7. A cutting tool of claim 3, wherein the prism holder is radially biased by a pin through a spring at the middle portion thereof, and is pivotally connected to one end of an adjusting screw, while another end of the adjusting screw is threaded on a second adjusting knob, and wherein a screw is mounted on the pivot shaft and at the direction biased by the pin.

8. A cutting tool of claim 7, wherein the pivot shaft is fixed relative to the bracket.

9. A cutting tool of claim 7, wherein the pivot shaft is fixed relative to the cutting assembly.
